(19) United States
(12) Patent Application Publication
(10) Pub. No.: US 2024/0289242 A1
(43) Pub. Date: Aug. 29, 2024

(54) INPUT/OUTPUT (I/O) COMPONENT TESTING

(71) Applicant: Micron Technology, Inc., Boise, ID (US)

(72) Inventors: Ming-ta Hsieh, Woodbury, MN (US); Taylor Loftsgaarden, Eden Prairie, MN (US)

(21) Appl. No.: 18/444,502

(22) Filed: Feb. 16, 2024

Related U.S. Application Data
(60) Provisional application No. 63/448,862, filed on Feb. 28, 2023.

(51) Int. Cl. G06F 11/263; G06F 11/22

(52) U.S. Cl. CPC G06F 11/263; G06F 11/2221

(57) ABSTRACT

I/O components can be tested in a collective manner. I/O components can be linked such that a test signal is transmitted through the I/O components (e.g., by being propagated from one I/O component to another I/O component) such that the I/O components are tested via a single transmission of the test signal.

### PRIORITY INFORMATION

This application claims the benefit of U.S. Provisional Application No. 63/448,862, filed on Feb. 28, 2023, the contents of which are incorporated herein by reference.

### TECHNICAL FIELD

The present disclosure relates generally to semiconductor memory and methods, and more particularly, to apparatuses, systems, and methods for input/output (I/O) component testing.

### BACKGROUND

Memory devices are typically provided as internal, semiconductor, integrated circuits in computers or other electronic systems. There are many different types of memory including volatile and non-volatile memory. Volatile memory can require power to maintain its data (e.g., host data, error data, etc.) and includes random access memory (RAM), dynamic random access memory (DRAM), static random access memory (SRAM), synchronous dynamic random access memory (SDRAM), and thyristor random access memory (TRAM), among others. Non-volatile memory can provide persistent data by retaining stored data when not powered and can include NAND flash memory, NOR flash memory, ferroelectric random-access memory (FeRAM), and resistance variable memory such as phase change random access memory (PCRAM), resistive random access memory (RRAM), and magnetoresistive random access memory (MRAM), such as spin torque transfer random access memory (STT RAM), among others.

Memory devices may be coupled to a host (e.g., a host computing device) to store data, commands, and/or instructions for use by the host while the computer or electronic system is operating. For example, data, commands, and/or instructions can be transferred between the host and the memory device(s) during operation of a computing or other electronic system. A controller may be used to manage the transfer of data, commands, and/or instructions between the host and the memory devices.

### BRIEF DESCRIPTION OF THE DRAWINGS

FIG. 1 is a block diagram of an apparatus in the form of a computing system including a test component and input/output (I/O) components in accordance with a number of embodiments of the present disclosure.

FIG. 2 is a block diagram illustrating an example method of testing a group of I/O components in accordance with a number of embodiments of the present disclosure.

FIG. 3 is a block diagram illustrating another example method of testing a group of I/O components in accordance with a number of embodiments of the present disclosure.

FIG. 4 is a block diagram illustrating another example method of testing a group of I/O components in accordance with a number of embodiments of the present disclosure.

FIG. 5 is a block diagram illustrating another example method of testing a group of I/O components in accordance with a number of embodiments of the present disclosure.

FIG. 6 is a flow diagram of a method for I/O component testing in accordance with a number of embodiments of the present disclosure.

### DETAILED DESCRIPTION

Systems, apparatuses, and methods related to input/output (I/O) component testing are described. I/O circuits can include one or more signal lines for transmitting signals in one or more directions. Those I/O circuits that are capable of transmitting signals in one direction are referred to as “unidirectional” I/O circuits, while those I/O circuits that are capable of transmitting signals in two (e.g., opposite) directions are referred to as “bidirectional” I/O circuits. I/O circuits can include various parts, such as I/O pad, transceivers that may be coupled to each other and to the I/O pad, etc. I/O circuits can be implemented in various components of memory systems, including, but not limited to, controllers, buffers, ports, interfaces, etc.

Testing (e.g., training) I/O circuits involves transmitting data through the I/O circuits and checking whether the data received from the I/O circuits match the data as originally transmitted. In some approaches, the I/O circuits are individually evaluated. For example, multiple test signals are respectively transmitted to I/O circuits, and the signals received from each component are separately compared to the original transmitted signals to verify the accuracy (e.g., whether they match or not). However, this approach may require more testing time, resulting in higher associated costs.

Aspects of the present disclosure address the above and other challenges associated with testing I/O circuits. In embodiments of the present disclosure, I/O circuits (alternatively referred to as “I/O components” herein) can be collectively tested via one or more signals that can be transmitted through (e.g., between) the I/O circuits without having to transmit signals separately and individually to each I/O circuit. In order to be collectively tested, I/O components can be linked in daisy chain configuration (e.g., a configuration in which the memory devices are connected together in a sequence, ring, or series) such that a signal received at one I/O component can be propagated to the other I/O components that are coupled to each other and outputted via a different one of the I/O components. A topology in which linked I/O components are coupled to each other can be dynamically configured by a test component, which can test different groups of I/O components, for example, to identify the I/O component causing the mismatch.

As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

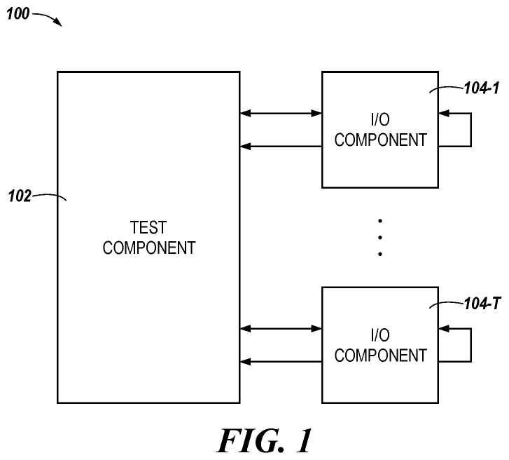

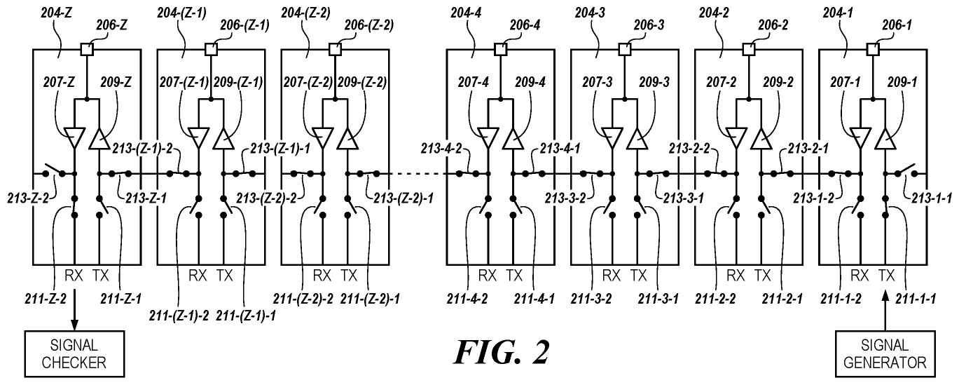

The figures herein follow a numbering convention in which the first digit or digits correspond to the drawing figure number and the remaining digits identify an element or component in the drawing. Similar elements or components between different figures may be identified by the use of similar digits. For example, 104 may reference element “04” in FIG. 1, and a similar element may be referenced as 204 in FIG. 2.

Analogous elements within a Figure may be referenced with a hyphen and extra numeral or letter. See, for example, elements 104-1, . . . , 104-T in FIG. 1. Such analogous elements may be generally referenced without the hyphen and extra numeral or letter. For example, elements 104-1, . . . , 104-T may be collectively referenced as 104. As used herein, the designators “N”, “M”, “X”, “Y” “Z”, “T”, particularly with respect to reference numerals in the drawings, indicates that a number of the particular feature so designated can be included. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention and should not be taken in a limiting sense.

FIG. 1 is a block diagram of an apparatus in the form of a computing system including a test component 102 and input/output (I/O) components 104-1, . . . , 104-T (collectively referred to as “I/Os 104”) in accordance with a number of embodiments of the present disclosure. As used herein, a test component 102 and I/Os 104 might also be separately considered an “apparatus.”

The I/Os 104 can include various circuitry to facilitate transmission of signals. For example, as further illustrated in FIGS. 2-5, I/Os 104 can include one or more signal lines, transceivers (e.g., transmitter, receiver, etc.), I/O pads, etc. that can receive an external signal (e.g., signal received from an external device, such as test component 102) and/or output the received signal (e.g., to test component 102). Although embodiments are not so limited, an I/O 104 can be a bidirectional I/O that can transmit/receive signals from/to an I/O pad.

Although embodiments are not so limited, I/Os 104 can form various buses (e.g., data buses, address buses, command buses, etc.) and can be placed in various locations of the computing system. For example, I/O components can be placed among peripheral devices (e.g., sensors, actuators, displays, etc.), a host (e.g., a desktop computer, laptop computer, network server, mobile device, or such computing device that includes a memory and a processing device), a controller, etc.

In some embodiments, one or more of I/Os 104 can be part of (e.g., form) a “port”, which may be a physical port, such as serial advanced technology attachment (SATA) ports, peripheral component interconnect express (PCIe) ports, universal serial bus (USB) ports, Fibre Channel ports, Serial Attached SCSI (SAS) ports, Small Computer System Interface (SCSI) ports, a dual in-line memory module (DIMM) ports, an NVM Express (NVMe) ports, Open NAND Flash Interface (ONFI) ports, etc.

The test component 102 can include various circuitry to facilitate an operation described herein, such as testing I/Os (e.g., during manufacturing and testing phases). For example, the test component 102 can include special purpose circuitry in the form of an ASIC, FPGA, state machine, and/or other logic circuitry or software and/or firmware that can allow the test component 102 to test I/Os 104. As an example, the test component 102 can be and/or include a simple computer-controlled digital multimeter, or a complicated system containing dozens or more complex test instruments (real or simulated electronic test equipment) capable of automatically testing and diagnosing faults in sophisticated electronic packaged parts or on wafer testing, including systems on chips and/or integrated circuits that includes I/Os (e.g., I/Os 104).

The test component 102 can be coupled to I/Os 104 on both ends (e.g., one end including an I/O pad 206 and an opposite end coupled to switches 211) to input a signal on either side of I/Os 104 and/or receive a signal from the I/Os 104 via either side of I/Os 104.

As further illustrated in FIGS. 2-5, I/Os 104 can include signal lines that can link one I/O component 104 to the other I/Os 104. These linked I/Os 104 can be selectively coupled to each other to allow a signal received at one of the coupled I/Os 104 to be transmitted through the coupled I/Os 104. As further illustrated in FIGS. 2-5, each I/O component 104 can include one or more switches that can be used to selectively couple the respective I/O component to the other I/Os 104 or selectively decouple the respective I/Os from the other I/Os 104.

The test component 102 can test I/Os 104 by generating and inputting (e.g., transmitting) a test signal (e.g., a signal indicative of a test data pattern) to one or more I/Os 104 and determining whether the signal returned (e.g., received) from the I/Os 104 match the initially input signal. A mismatch between the two signals can indicate defects in the tested I/Os 104.

The test component 102 can test I/Os 104 in a collective manner without testing them each individually/separately. For example, when being tested, the test component 102 can be configured to those I/Os 104 (e.g., I/Os desired to be tested) to be linked together and transmit a test signal to the linked I/Os 104 without necessarily transmitting multiple signals to the I/Os 104, respectively. Accordingly, a single transmission of the test data pattern can indicate defects on the linked I/Os 104. Further details associated with the test on linked I/Os 104 are described in connection with FIGS. 2-4.

The test component 102 can dynamically configure (e.g., alter) topology of two or more I/Os 104 (e.g., a topology in which I/Os 104 are coupled to each other) by enabling and/or disabling various switches (e.g., switches 211 and/or 213 illustrated in FIG. 2) of the I/Os 104. For example, the test component 102 can configure the topology to select one I/O component 104 as a receiving device for receiving a test signal from the test component 102, to select a different I/O component 104 as an output device for outputting the test signal back to the test component 102, and/or to couple I/Os 104 to each other in various manners. Accordingly, prior to transmitting a test signal, the test component 102 can configure the topology of I/Os 104 to determine a group of I/Os 104 that are to be tested.

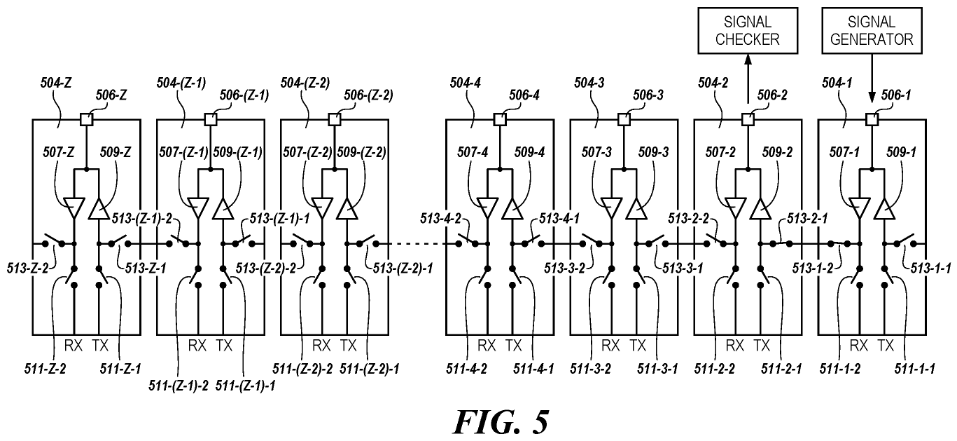

In the event that the defects are indicated (e.g., in response to the signal received at the test component 102 not matching the signal transmitted to the I/Os 104), the test component 102 can reconfigure the topology of I/Os 104 to further perform supplemental tests on subsets of the previously coupled I/Os 104 to further identify one or more I/Os 104 causing the mismatch. For example, each subset on which a respective supplemental test is performed can include one or two I/Os. Further details associated with the supplemental testing are described in connection with FIG. 5.

FIG. 2 is a block diagram illustrating an example method of testing a group of (e.g., abutted) I/O components 204-1, . . . , 204-Z in accordance with a number of embodiments of the present disclosure. The I/O components 204-1, . . . , 204-Z can be analogous to the I/O components 104 illustrated in FIG. 1.

As illustrated in FIG. 2, the I/O components 204 include respective I/O pads 206-1 to 206-Z, respective transmitters 209-1 to 209-Z (e.g., to transmit a signal to the I/O pad 206), respective receivers 207-1 to 207-Z (e.g., to receive a signal from the I/O pad 206), and a number of switches 211 and 213. For example, an I/O component 204-1 includes an I/O pad 206-1, a transmitter 209-1, a receiver 207-1, and a number of switches 211-1-1, 211-1-2, 213-1-1, and 213-1-2. Although embodiments are not so limited, switches 211 and/or 213 can be a Complementary Metal-Oxide-Semiconductor (CMOS)-based transmission gate switch, which can be controlled by a digital signal (e.g., transmitted from the test component 102 illustrated in FIG. 1).

As used herein, the term “transmitter” can be alternatively referred to as “transmit driver”, “input driver”, etc. Further, the term “receiver” can be alternatively referred to as “receiver driver”, “output driver”, etc. As illustrated in FIG. 2, the transmitter 209 as an input driver is operable to drive a signal (e.g., received externally) to an I/O pad (e.g., I/O pad 206) and while the receiver 307 as an output driver is operable to drive a signal received from the I/O pad, such as I/O pad 206.

The switches 211 of the I/O component 204 can be respectively located on (e.g., coupled to) signal lines for receiving a signal (e.g., from the test component 102 illustrated in FIG. 1) and outputting a signal (e.g., to the test component 102 illustrated in FIG. 1). Further, the switches 213 of the I/O component 204 can be respectively located on (e.g., coupled to) signal lines coupling at least two I/O components 204. For example, the I/O components 204-1 and 204-2 are coupled to each other via switches 213-1-2 and 213-2-1; the I/O components 204-2 and 204-3 are coupled to each other via switches 213-2-2 and 213-3-1; the I/O components 204-3 and 204-4 are coupled to each other via switches 213-3-2 and 213-4-1; the I/O components 204-(Z-2) and 204-(Z-1) are coupled to each other via switches 213-(Z-2)-2 and 213-(Z-1)-1; and the I/O components 204-(Z-1) and 204-Z are coupled to each other via switches 213-(Z-1)-2 and 213-Z-1.

As I/O components 204-1 and 204-Z are located on respective ends of the “chain,” a switch 213-1-1 of the I/O component 204-1 and a switch 213-Z-2 of the I/O component 204-Z can be in an open position to decouple the I/O components 204-1 and 204-Z on each end. Further, switches 211 (except for switches 211-1-1 and 211-Z-2) of the I/O components 204 can be in an open position to decouple the I/O components so as not to receive a signal externally (e.g., from the test component 102 illustrated in FIG. 1). The switches 211-1-1 of the I/O component 204-1 and 211-Z-2 of the I/O component 204-Z can be in a closed position to receive a signal from the test component 102 and/or transmit (e.g., output) a signal to the test component 102.

The I/O components 204 can be tested by transmitting a test signal on one end of the I/O components 204 and determining whether a signal (alternatively referred to as “output signal”) received from another end of the I/O components 204 matches to the test signal as initially input. For example, as illustrated in FIG. 2, a test signal (e.g., from a “signal generator” shown in FIG. 2 that is part of the test component 102 illustrated in FIG. 2) can be generated and input (e.g., from the test component 102) to the I/O component 204-1 via a signal line coupled to the transmitter 209-1. The signal can be propagated to (e.g., transmitted through) the I/O components 204-2, . . . , 204-(Z-1) and to the I/O component 204-Z via a signal line constructed via the switches 213-1-2, 213-2-1, 213-2-2, 213-3-1, 213-3-2, 213-4-1, 213-4-2, 213-(Z-2)-1, 213-(Z-2)-2, 213-(Z-1)-1, 213-(Z-1)-2, and 213-Z-1. The test signal received at the I/O component 204-Z can be transmitted (e.g., outputted) back to (e.g., a “signal checker” of) the test component 102 via a signal line constructed via switch 211-Z-2. Accordingly, the I/O components 204 can be tested as a group (e.g., via transmission of a single signal) without having to test each I/O component 204 individually.

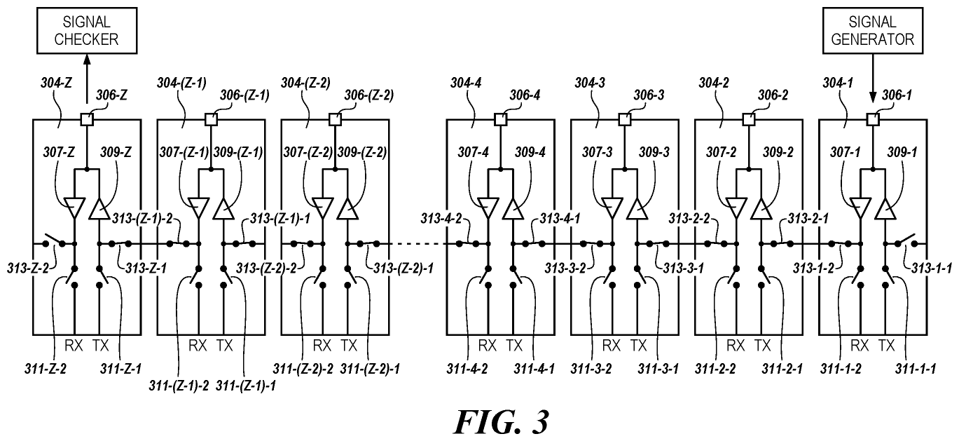

FIG. 3 is a block diagram illustrating another example method of testing a group of (e.g., abutted) I/O components 304-1, . . . , 304-Z in accordance with a number of embodiments of the present disclosure. The I/O components 304-1, . . . , 304-Z can be analogous to the I/O component 104 illustrated in FIG. 1.

FIG. 3 is generally analogous to FIG. 2 except that the I/O components 304 are configured to receive and/or transmit a signal via respective I/O pads 306. For example, as illustrated in FIG. 3, switch 311-1-1 and 311-Z-2 can be in an open position to decouple respective signal lines from test component 102 illustrated in FIG. 1.

In an example embodiment illustrated in FIG. 3, the I/O components 304 can be tested by transmitting (e.g., from a “signal generator” shown in FIG. 3 that is part of the test component 102) a test signal to the I/O component 304-1 via an I/O pad 306-1. The test signal can be propagated to (e.g., transmitted through) the I/O components 304-2, . . . , 304-(Z-1) and to the I/O component 304-Z via a signal line constructed via the switches 313-1-2, 313-2-1, 313-2-2, 313-3-1, 313-3-2, 313-4-1, 313-4-2, 313-(Z-2)-1, 313-(Z-2)-2, 313-(Z-1)-1, 313-(Z-1)-2, and 313-Z-1. The test signal received at the I/O component 304-Z can be transmitted (e.g., outputted) back to (e.g., a “signal checker” of) the test component 102 via an I/O pad 306-Z. Accordingly, the I/O components 304 can be collectively tested as a group (e.g., via transmission of a single signal) without having to transmit (e.g., from the test component 102) multiple test signals to the I/O component 304 individually.

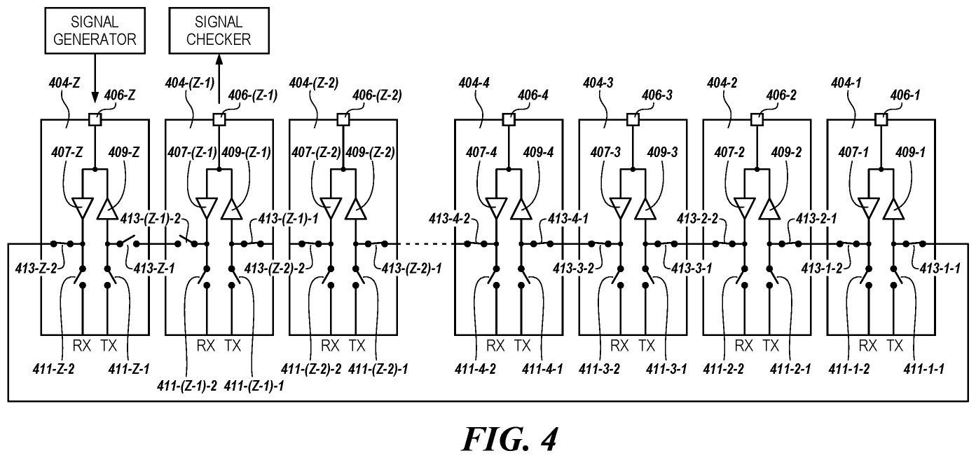

FIG. 4 is a block diagram illustrating another example method of testing a group of (e.g., abutted) I/O components 404-1, . . . , 404-Z in accordance with a number of embodiments of the present disclosure. The I/O components 404-1, . . . , 404-Z can be analogous to the I/O component 104 illustrated in FIG. 1.

FIG. 4 is generally analogous to FIG. 3 except that the I/O components 404 are linked in a daisy chain configuration (e.g., a configuration in which the memory devices are connected together in a sequence, ring, or series). For example, the I/O components 404 are linked to each other in a manner that any one of the I/O components 404 can be configured to receive a test signal (e.g., from the test component 102) for the I/O components 404 illustrated in FIG. 4 (e.g., such that the signal can be propagated to (e.g., transmitted through) the entire set of I/O components 404). More particularly, as illustrated in FIG. 4, a test signal can be received (e.g., from a “signal generator” shown in FIG. 4 that is part of the test component 102 illustrated in FIG. 2) at the I/O component 404-Z, propagated to (e.g., transmitted through) the I/O components 404-1, . . . , 404-(Z-1), and outputted at the I/O component 404-(Z-1) (e.g., to a “signal checker” of the test component 102) as the I/O components 404-1 and 404-Z are coupled to each other. Switches 413-(Z-1)-2 and 413-Z-1 can be in an open position to ensure that the signal is outputted at the I/O component 404-(Z-1) (e.g., without being further transmitted to the I/O component 404-Z).

FIG. 5 is a block diagram illustrating another example method of testing a group of (e.g., abutted) I/O components in accordance with a number of embodiments of the present disclosure. The I/O components 504-1, . . . , 504-Z can be analogous to the I/O component 104 illustrated in FIG. 1.

FIG. 5 is generally analogous to FIG. 3 and/or FIG. 4 except that a signal may not be transmitted through the entire I/O components 504 shown in FIG. 5. Instead, the I/O components 504-1 and 504-2 are coupled to each other, while the other I/O components 504 are not, as illustrated in FIG. 5. Accordingly, a signal received (e.g., from a “signal generator” shown in FIG. 5 that is part of the test component 102 illustrated in FIG. 2) at the I/O component 504-1 can be outputted from the I/O component 504-2 (e.g., to a “signal checker” of the test component 102) without being propagated to (e.g., transmitted through) the other I/O components, such as I/O components 504-3, 504-4, 504-(Z-2), 504-(Z-1), and 504-Z.

The testing method illustrated/described in connection with FIG. 5 can be performed as a supplemental test in addition to those tests performed as described in connection with FIG. 2, 3, and/or FIG. 4. For example, if the test performed on the I/O components 504-1, . . . , 504-Z shows that the received signal at the test component 102 does not match the initially input signal (e.g., input to one of the I/O components 504-1, . . . , 504-Z), supplemental tests can be respectively performed on subsets (e.g., each subset including two I/O components, such as I/O components 504-1 and 504-2) to further identify one or more I/O components 504 causing the mismatch. Although FIG. 5 illustrates that two I/O components are tested on each supplemental test, embodiments are not so limited. For example, a single I/O component can be tested on each supplemental test instead of two.

A subset may not be tested again if the mismatch between the input and output signals is not discovered, while I/O components of a subset on which the mismatch is discovered can be tested individually to further identify one or more I/O components causing the mismatch. For example, if the supplemental test performed on the I/O components 504-1 and 504-2 results in the mismatch, further supplemental tests can be performed respectively and individually on the I/O components 504-1 and 504-2.

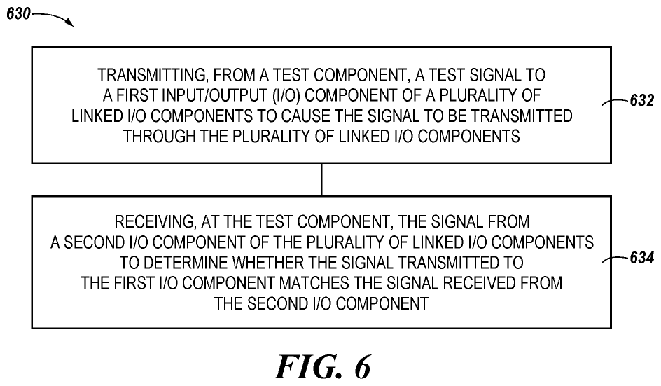

FIG. 6 is a flow diagram 630 of a method for input/output (I/O) component tests in accordance with a number of embodiments of the present disclosure. The method as illustrated by the flow diagram 630 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by the test component 102 illustrated in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At 632, a test signal can be transmitted (e.g., from the test component 102) to a first input/output (I/O) component of a plurality of linked I/O components (e.g., I/O components 104, 204, 304, 404, and/or 504 illustrated in FIGS. 1-5, respectively) to cause the signal to be transmitted through (e.g., propagated among) the plurality of linked I/O components. In some embodiments, the other I/O components (e.g., I/O components 204-2, . . . , 204-(Z-1) illustrated in FIG. 2) of the plurality of linked I/O components can be decoupled from the test component 102 to prevent a test signal from being transmitted (e.g., from the test component 102) to each one of the other I/O components.

In some embodiments, prior to transmitting the signal to the first I/O component (e.g., the I/O component 204-1 illustrated in FIG. 2), the first I/O component can be coupled to the test component 102 via a first end of the first I/O component and one I/O component (e.g., the I/O component 204-2 illustrated in FIG. 2) of the plurality of linked I/O components, while a second end of the first I/O component is decoupled from the test component.

At 634, the signal can be received at the test component 102 from a second I/O component (e.g., the I/O component 204-Z illustrated in FIG. 2) of the plurality of linked I/O components to determine whether the signal transmitted to the first I/O component matches the signal received from the second I/O component. In some embodiments, prior to transmitting the signal to the first I/O component, the second I/O component can be coupled to the test component via a first end of the second I/O component and one I/O component (e.g., the I/O component 204-(Z-1) illustrated in FIG. 2) of the plurality of linked I/O components, while a second end of the second I/O component is decoupled from the test component.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and processes are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus, comprising:
a plurality of input/output (I/O) components, each I/O component including:
an I/O pad; and
a transceiver component coupled to the I/O pad via a first signal line; and
wherein at least two I/O components of the plurality of I/O components are linked such that a signal can be transmitted between respective transceiver components of the at least two I/O components.

2. The apparatus of claim 1, wherein the plurality of I/O components are bidirectional I/O components, and wherein the transceiver component comprises a transmitter and a receiver.

3. The apparatus of claim 2, wherein at least one of the plurality of linked I/O components comprises a respective first set of switches respectively coupled to the transmitter and the receiver, the respective first set of switches configured to selectively receive a signal for, or output a signal from, the at least one of the plurality of linked I/O components.

4. The apparatus of claim 3, wherein:
the respective first set of switches is configured to, in an open position, decouple the at least one of the plurality of linked I/O components from a signal generator from which the signal is received; and
the respective first set of switches is configured to, in a closed position, couple the at least one of the plurality of linked I/O components to the signal generator.

5. The apparatus of claim 1, wherein at least one of the plurality of linked I/O components comprises a respective second set of switches configured to selectively couple the at least one of the plurality of linked I/O components to one or more I/O components of the plurality of linked I/O components.

6. The apparatus of claim 5, wherein the at least two I/O components of the plurality of I/O components are linked in a daisy-chain configuration via the respective sets of switches of the at least two I/O components.

7. The apparatus of claim 5, wherein:
the respective second set of switches is configured to, in an open position, decouple the at least one of the plurality of linked I/O components from the one or more I/O components of the plurality of linked I/O components; and
the respective second set of switches is configured to, in a closed position, couple the at least one of the plurality of linked I/O components to the one or more I/O components of the plurality of linked I/O components.

8. The apparatus of claim 1, wherein the signal is a test signal, wherein the at least two I/O components of the plurality of I/O components are configured to be tested via the test signal provided to a first I/O component, and wherein the test signal is propagated from the first I/O component to a second I/O component.

9. The apparatus of claim 1, wherein the plurality of I/O components are configured to be tested via a test signal provided by a signal generator to an I/O pad of a first I/O component of the plurality of I/O components, and wherein the test signal is propagated to an I/O pad of a second I/O component of the plurality of I/O components.

10. A system, comprising:
a test component; and
a plurality of linked input/output (I/O) components coupled to one another and to the test component;
wherein the test component is configured to:
transmit a test signal to a first I/O component of the plurality of linked I/O components to cause the signal to be further transmitted to a second I/O component via one or more I/O components of the plurality of linked I/O components; and
receive the signal from the second I/O component to determine whether the signal transmitted to the first I/O component matches the signal received from the second I/O component.

11. The system of claim 10, wherein each I/O component of the plurality of linked I/O components comprises:
a first set of switches via which the respective I/O component is coupled to one or more I/O components of the plurality of linked I/O components; and
a second set of switches via which the respective I/O component is coupled to one end of the respective I/O component.

12. The system of claim 11, wherein each I/O component of the plurality of linked I/O components comprises a respective I/O pad that is coupled to a different end than the one end.

13. The system of claim 11, wherein the test component is configured to, to receive the signal from the second I/O component:
enable at least one of the first set of switches of each I/O component to couple each I/O component to one another; and
disable the second set of switches.

14. The system of claim 11, wherein the test component is configured to reconfigure, in response to the signal transmitted to the first I/O component not matching to the signal received from the second I/O component, the respective second set of switches of one or more I/O components of the plurality of linked I/O components to couple a subset of the plurality of linked I/O components to one another.

15. The system of claim 14, wherein the test component is configured to:
transmit a test signal to a third I/O component of the subset of the plurality of linked I/O components that is located at a first end of the subset to cause the signal to be further transmitted to a fourth I/O component located at a second end of the subset via one or more I/O components of the subset; and
receive the signal from the fourth I/O component to determine whether the signal transmitted to the third I/O component of the subset matches the signal received from the fourth I/O component.

16. The system of claim 14, wherein the subset of the plurality of linked I/O components includes two I/O components.

17. A method, comprising:
transmitting, from a test component, a test signal to a first input/output (I/O) component of a plurality of linked I/O components to cause the signal to be transmitted through the plurality of linked I/O components; and
receiving, at the test component, the signal from a second I/O component of the plurality of linked I/O components to determine whether the signal transmitted to the first I/O component matches the signal received from the second I/O component.

18. The method of claim 17, further comprising, prior to transmitting the signal to the first I/O component:
coupling the first I/O component to:
the test component via a first end of the first I/O component; and
one I/O component of the plurality of linked I/O components; and
decoupling a second end of the first I/O component from the test component.

19. The method of claim 17, further comprising, prior to transmitting the signal to the first I/O component:
coupling the second I/O component to:
the test component via a first end of the second I/O component; and
one I/O component of the plurality of linked I/O components; and
decoupling a second end of the second I/O component from the test component.

20. The method of claim 17, further comprising decoupling the other I/O components of the plurality of linked I/O components from the test component to prevent a test signal from being transmitted to each one of the other I/O components.
